(19) United States
(12) Patent Application Publication
(10) Pub. No.: US 2015/0026959 A1
(43) Pub. Date: Jan. 29, 2015

(54) CONSTRUCTION RETENTION DEVICE

(71) Applicants: Terin Dumas, Fullerton, CA (US); Michael Joseph Chudilowsky, Paramount, CA (US)

(72) Inventors: Terin Dumas, Fullerton, CA (US); Michael Joseph Chudilowsky, Paramount, CA (US)

(21) Appl. No.: 13/948,938

(22) Filed: Jul. 23, 2013

(51) Int. Cl. B25H 1/00; B25B 11/00; B25H 1/10; F16M 11/42

(52) U.S. Cl. CPC B25H 1/0035; F16M 11/42; B25B 11/00; B25H 1/0042; B25H 1/10
USPC 29/559; 269/86; 269/240; 269/17

(57) ABSTRACT

A construction retention device comprising: a first member, a second member and an inner member; wherein the first member comprises a base and an upright; wherein the upright of the first member has at least a single holder; wherein the second member comprises a base and an upright; wherein the upright of the second member has at least a single holder; wherein the first member and the second member are connected to the inner member.

### FIELD OF THE SUBJECT MATTER

The field of the subject matter relates to construction retention devices, in particular, a device that will hold a door, window, gate, panel or other flat surface upright so that it may be painted or worked on from multiple sides at the same time, without having to wait for one side to dry in order to access any other side.

### BACKGROUND

Flat panels, such as doors, windows, gates and other flat surfaces are generally time consuming and difficult to paint or perform work on, because a newly painted or stained surface must be allowed to properly dry and cure before flipping it over in order to paint the other side. Clearly, this problem presents both time and logistical constraints. In some instances, carpenters and construction workers solve this problem by using a sawhorse or propping the panel up against a wall. This temporary solution is problematic for many reasons, including the fact that the sawhorse still won't accommodate the painted or stained panel until the other corresponding side is dry, propping the panel up against a wall is sloppy and may not be safe for those walking near those walls, the newly painted or stained surface may be damaged during the transition, and there may be a lack of space around the area, thus requiring the door or panel to stay upright and secure.

In order to paint, stain or work on flat panels, the carpenter, painter or construction worker requires access to the front and back as well as the left and right side and often times, the top.

There are prior art “stands” that hold a door upright. For example, there are stands that appear to have arms or blocks that are placed in the front and back of the door in order to hold it upright. However, because of their construction, the doors and panels are not stable and the front and back surfaces are obstructed by the arms of the stands and thus they are unable to be worked on or painted properly.

Therefore, it would be ideal to provide a better way of allowing doors and other flat panels to be painted, stained and/or worked on without the time and hassle of waiting for one side to be completed.

### SUMMARY

A construction retention device comprising: a first member, a second member and an inner member; wherein the first member comprises a base and an upright; wherein the upright of the first member has at least a single holder; wherein the second member comprises a base and an upright; wherein the upright of the second member has at least a single holder; wherein the first member and the second member are connected to the inner member.

A construction retention device comprising: a first member, a second member and an inner member; wherein the first member comprises a base and an upright; wherein the upright of the first member has a plurality of holders; wherein the second member comprises a base and an upright; wherein the upright of the second member has a plurality of holders; wherein the first member has a hollow portion; wherein the second member has a hollow portion; wherein the inner member is placed within the hollow portion of the first member and hollow portion of the second member; wherein the first member and second member are moveable along the inner member.

A method of using a construction retention device having a first member, a second member and an inner member; wherein the first member comprises a base and an upright; wherein the upright of the first member has at least a single holder; wherein the second member comprises a base and an upright; wherein the upright of the second member has at least a single holder; wherein the panel is placed between the upright of the first member and the upright of the second member; wherein the at least single holder of the upright of the first member is fastened to the panel; wherein the at least single holder of the upright of the second member is fastened to the panel.

### BRIEF DESCRIPTION OF THE FIGURES

By way of example only, selected embodiments and aspects of a contemplated embodiment are described below. Each such description refers to a particular figure (“FIG.”) which shows the described matter. Each such figure includes one or more reference numbers that identify one or more part(s) or element(s) of the contemplated embodiment.

FIG. 1 shows a contemplated embodiment of the device and a door.

FIG. 2 shows a contemplated embodiment of the device.

FIG. 3 shows an exploded view of a contemplated embodiment of the device.

FIG. 4 shows a contemplated embodiment of the device.

FIG. 5 shows a contemplated embodiment of the device.

### DETAILED DESCRIPTION

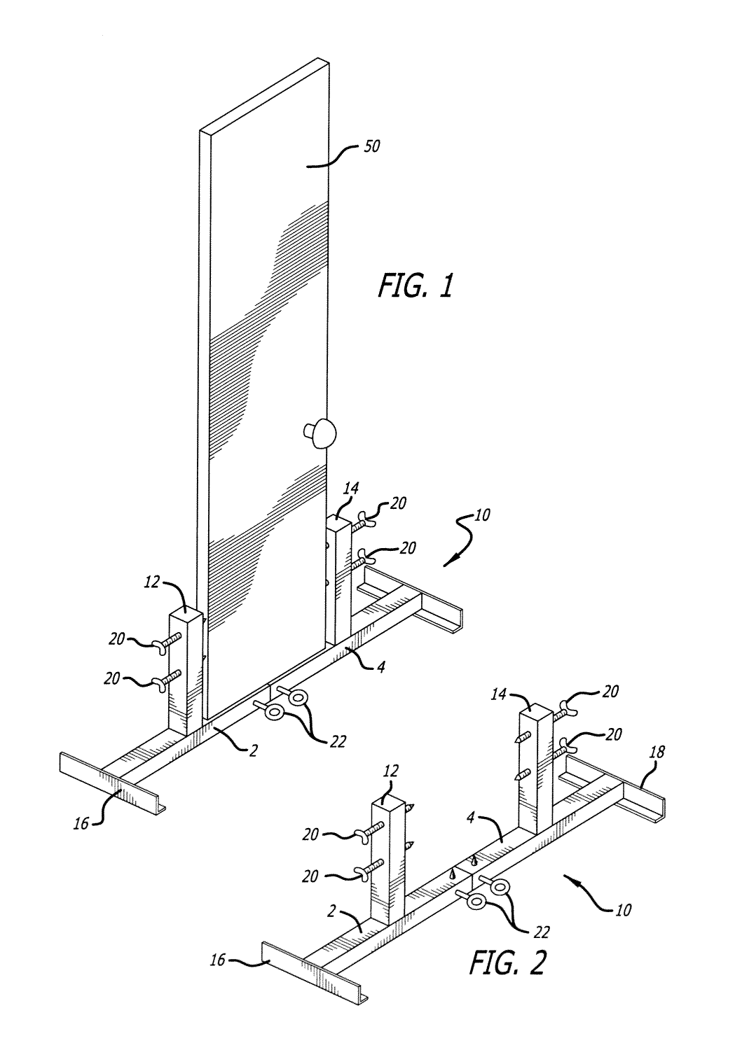

FIG. 1 shows a contemplated embodiment of the device 10 holding a door 50 upright.

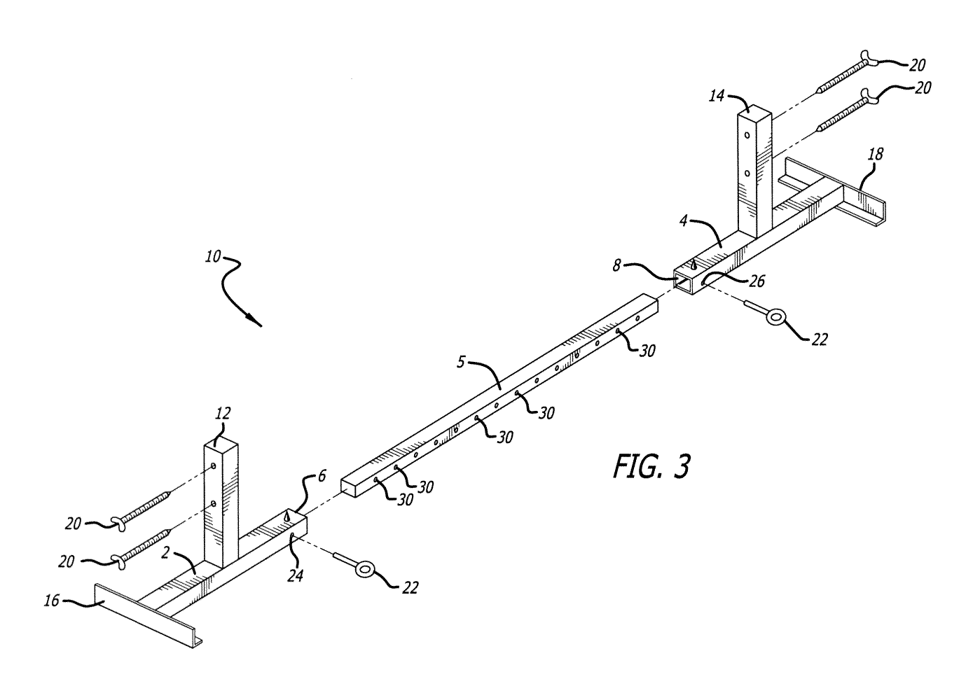

As shown in FIG. 1, the device 10 has a base comprising members 2 and 4. Members 2 and 4 are joined together by an inner member 5 (not shown). Members 2 and 4 are fastened to the inner member 22, which is described below and shown in FIG. 3, by screws 22 that may be hand tightened. The base may be made of any suitable material, including steel, aluminum, wood, plastic, or a combination thereof. The inner member 5 may be a separate piece or part of one of members 2 or 4. The base may also have casters or other rolling devices attached to it.

As shown in FIG. 1, members 2 and 4 have individual stands 16 and 18, respectively. The stands may be placed at the end of members 2 and 4 or at a location close to the ends of members 2 and 4.

As shown in FIG. 1, the device has two uprights 12 and 14 connected to the two members 2 and 4, respectively. Uprights 12 and 14 have holders 20. The holders 20 can be any suitable gripping or coupling device, including screws, high friction grips or device combination thereof. The holders 20 may be hand tightened or tightened using a wrench, screwdriver or other suitable tool. The holders 20 are tightened to the door 50 in order to hold it in place and upright. The holders 20 extend through each of the uprights 12 and 14, in order to fasten and hold the door 50 upright. Each upright 12 and 14 has at least a single holder 20. In alternative embodiments, a plurality of holders 20 may be used. In alternative embodiments, members 2 and 4 each have a pin. The pins prevent the door 50 from sheering or tilting back and forth.

FIG. 2 shows a contemplated embodiment of the device 10. Member 2 has base 16 and upright 12. Member 4 has base 18 and upright 14. The screws 22 secure and adjust member 2 and member 4. If so desired, the distance between member 2 and member 4 may be widened or narrowed for the specific purpose, by adjusting screws 22. Member 2 and member 4 each have a pin 28. Pins 28 may be a cone shaped, cylindrical or other similar shaped object that extends upwards from member 2 and member 4.

FIG. 2 shows the holders 20 which are fastened and tightened to the door, window, gate, patent or any other flat panel in order to hold it upright.

FIG. 3 shows an exploded view of a contemplated embodiment of the device 10. Member 2 has a base 16 and an upright 12. Member 4 has a base 18 and an upright 14. Member 2 and member 4 have a hollow portion 6 and hollow portion 8, respectfully. Inner member 5 is placed within hollow portion 6 of member 2 and hollow portion 8 of member 4. Member 2 has a hole 24 and member 4 has a hole 26 that allows screw 22 to pass and be tightened through each hole 24 and/or 26. Inner member 5 has a plurality of holes 30 that allows screw 22 to pass and be tightened through it. The screws 22 pass through member 2, member 4 and inner member 5 and allow them to be secured to one another. It also allows the adjustment of the width of the device 10 by spacing apart member 2 and member 4 from each other along inner member 5. The screws are placed through hole 24 and hole 26 and through or on two of the holes 30. The holes 30 may be physical holes or extruded portions or extrusions of inner member 5.

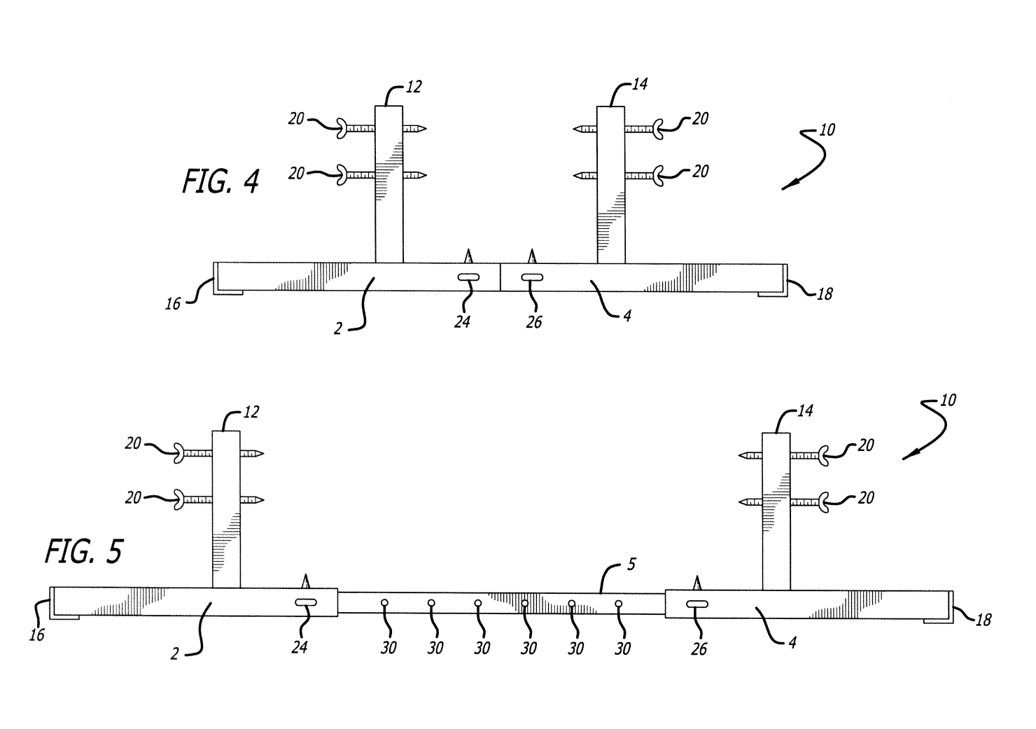

FIG. 4 shows a contemplated embodiment of the device 10 in its most contracted configuration. Member 2 and member 4 are directly next to each other.

FIG. 5 shows a contemplated embodiment of the device 10 in an extended configuration in which the width is widened. The member 2 and member 4 are spaced apart on inner member 5. The width of the device 10 may be extended manually. However, other embodiments may allow the width to be extended pneumatically or electrically.

Thus, specific embodiments of a construction retention device have been disclosed. It should be apparent, however, to those skilled in the art that many more modifications besides those already described are possible without departing from the inventive concepts herein. The inventive subject matter, therefore, is not to be restricted except in the spirit of disclosure herein. Moreover, in interpreting the specifications and claims, all terms should be interpreted in the broadest possible manner consistent with the context. In particular, the terms “comprises” and “comprising” should be interpreted as referring to elements, components, or steps in a non-exclusive matter, indicating that the referenced elements, components, or steps may be present, or utilized, or combined with other elements, components, or steps that are not expressly referenced.

What is claimed is:

1. A construction retention device comprising:
a first member, a second member and an inner member;
wherein the first member comprises a base and an upright;
wherein the upright of the first member has at least a single holder;
wherein the second member comprises a base and an upright;
wherein the upright of the second member has at least a single holder;
wherein the first member and the second member are connected to the inner member.

2. The construction retention device of claim 1, wherein the at least single holder of the upright of the first member and the at least single holder of the upright of the second member are screws.

3. The construction retention device of claim 1, wherein the at least single holder of the upright of the first member and the at least single holder of the upright of the second member are high friction grips.

4. The construction retention device of claim 1, wherein the first member has a hollow portion; wherein the second member has a hollow portion; wherein the inner member is placed within the hollow portion of the first member and the hollow portion of the second member.

5. The construction retention device of claim 4, wherein the first member has a hole and the second member has a hole and the inner member has a plurality of holes; wherein a first screw passes through the hole in the first member and a second screw passes through a hole in the second member; wherein the first screw aligns with a hole on the inner member and secures the first member; wherein the second screw aligns with a hole on the inner member and secures the second member.

6. The construction retention device of claim 1, wherein the first member and the second member have a plurality of casters.

7. The construction retention device of claim 1, wherein the first member and the second member are made from aluminum.

8. The construction retention device of claim 1, wherein the first member and the second member each have a pin.

9. A method of using the construction retention device of claim 1, wherein a panel is placed between the upright of the first member and the upright of the second member and the plurality of holders of the upright of the first member are secured to the panel and the plurality of holders of the upright of the second member are secured to the panel.

10. A construction retention device comprising:
a first member, a second member and an inner member;
wherein the first member comprises a base and an upright;
wherein the upright of the first member has a plurality of holders;
wherein the second member comprises a base and an upright;
wherein the upright of the second member has a plurality of holders;
wherein the first member has a hollow portion;
wherein the second member has a hollow portion;
wherein the inner member is placed within the hollow portion of the first member and hollow portion of the second member;
wherein the first member and second member are moveable along the inner member.

11. The construction retention device of claim 10, wherein the holders are screws.

12. The construction retention device of claim 10, wherein the holders are high friction surface grips.

12. The construction retention device of claim 10, wherein the first member and the second member have a plurality of casters.

13. The construction retention device of claim 10, wherein the first member and the second member are made from aluminum.

14. The construction retention device of claim 10, wherein the first member and the second member each have a pin.

15. A method of using the construction retention device of claim 10, wherein a panel is placed between the upright of the first member and the upright of the second member and the plurality of holders of the upright of the first member are secured to the panel and the plurality of holders of the upright of the second member are secured to the panel.

16. A method of using a construction retention device having
a first member, a second member and an inner member;
wherein the first member comprises a base and an upright;
wherein the upright of the first member has at least a single holder;
wherein the second member comprises a base and an upright;
wherein the upright of the second member has at least a single holder;
wherein the panel is placed between the upright of the first member and the upright of the second member;
wherein the at least single holder of the upright of the first member is fastened to the panel;
wherein the at least single holder of the upright of the second member is fastened to the panel.

17. The construction retention device of claim 16 wherein the first member has a hollow portion; wherein the second member has a hollow portion; wherein the inner member is placed within the hollow portion of the first member and hollow portion of the second member; wherein the first member and second member are moveable along the inner member.

18. The construction retention device of claim 16, wherein the at least single holder of the upright of the first member and the at least single holder of the upright of the second member are screws.

19. The construction retention device of claim 16, wherein a width between the first member and the second member is adjusted for a width of the panel.

20. The construction retention device of claim 16, wherein the first member and the second member are made from aluminum.
